(19) United States
(12) Patent Application Publication
(10) Pub. No.: US 2009/0094174 A1
(43) Pub. Date: Apr. 9, 2009

(54) METHOD, SYSTEM AND PROGRAM PRODUCT FOR ON DEMAND DATA MINING SERVER WITH DYNAMIC MINING MODELS

(75) Inventor: Timo Kussmaul, Boeblingen (DE)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 11/865,163

(22) Filed: Oct. 9, 2007

(51) Int. Cl. G06F 15/18

(52) U.S. Cl. 706/12

(57) ABSTRACT

The present invention in various implementations provides a method, system and computer program product for dynamically determining data mining results using a dynamic data mining model within a data mining system. The present invention, in accordance with various implementations, in part, creates a mining model for an event request that includes a plurality of mining rule sets determined in relation to the event and one or more business objectives and selected computations.

### FIELD OF THE INVENTION

The present invention relates generally to the field of data management and more specifically to improved data mining of data involving predetermined mining rules.

### BACKGROUND OF THE INVENTION

Data mining is a popular term that is used throughout many industries to, in some cases correctly relate the sorting and analysis of often large amounts of data for its respective relevant information, and in other cases misuse the terminology to include non-performing applications such as those used to automate the creation of charts or graphs with historic trends and analysis.

Data mining is a technique that typically deals with the discovery and use of relevant information from common data sources to create valid, actionable knowledge, patterns and rules from those common data sources (i.e., databases or data streams). Data mining is often associated with business intelligence organizations, customer and retail-based records, and financial analysts, but it is also becoming quite common in the sciences, such as pharmaceutical and technology industries, to extract information from the sizable data sets generated therein.

Data mining is typically performed by appointed systems, though such is not essential, and those systems may include in a data mining environment computers, standalone servers, communications, data sets, software applications, and the like, though such systems may be virtual, remotely accessible or shared. The systems are understood to often be incorporated into other software server systems such as databases, application servers, portals, enterprise service buses, messaging servers, groupware servers, and the like.

A server that is involved in performing a data mining operation (as used herein a “data mining server” or “mining server”) as part of or in cooperation with one of these systems typically accepts requests, which contain data that is to be mined (i.e., requests may contain a reference to data or information sought to be mined). For instance a request may include determining a classification, such as activity labeling or class labeling. Additionally, these requests may contain instructions related to the performance of the data mining specifics including references to return or relate the mined results.

It is understood that existing data mining servers typically compute mining results according to static mining models developed by an unassociated source, another mining component, or by the same mining server when operative in different mode. In this situation, as the mining model is static, it is also understood that existing data mining servers are unable to adapt to a dynamic environment having requirements that are different from the developed static model (e.g., reduced system load) and hence be less efficient in their operations.

Since the existing mining servers only have a single set of rules in relation to the static mining model, a data mining server is unable to react to characteristics of a dynamic environment which may include changing business objectives, modified requirements, changing system state, and the like. Therefore, existing mining servers are ill-equipped for dynamic, adaptive on-demand businesses, and particularly those where computing resources are dynamically assigned to various software services according to those dynamic environment characteristics.

Therefore, what is needed is a method for dynamically determining data mining results using a dynamic data mining model within a data mining system. The present invention addresses such a need.

### SUMMARY OF THE INVENTION

The present invention addresses such a need and sets forth a method, system and computer program product for dynamically determining data mining results using a dynamic data mining model within a data mining system.

The present invention, in accordance with various implementations, is a method system and computer program product for dynamically determining data mining results using a dynamic data mining model within a data mining system, the method comprising the data mining server having the steps of: receiving an event request, receiving a mining model for the event request that includes a plurality of mining rule sets determined in relation to the event and one or more business objectives and selected computations, determining a system environment for the event request and selecting one mining rule set, performing a mining operation in relation to the event request and the selected mining rule set, and determining data mining results.

The present invention in another implementation further includes the server receiving feedback information prior to evaluating the received preference functions and considering the received feedback information to finally determine a system environment for the event request. In this manner, the present invention is adaptive to changed system state parameters and may respond by selecting a different mining rule set in view of the changed system state.

### BRIEF DESCRIPTION OF THE DRAWINGS

FIG. 1 shows an operative flowchart for a data mining server in accordance with an implementation of the present invention;

FIG. 2 depicts a system for dynamically determining data mining results using a mining model with a data mining server in a data mining system in accordance with an implementation of the present invention; and

FIG. 3 depicts a process for creating mining rule sets within a mining model creation scheme by using selected computations in accordance with an implementation of the present invention.

### DETAILED DESCRIPTION

The present invention in various implementations relates generally to dynamically mining data in a data mining activity and more specifically to an improved data mining process relating business objectives, preference functions, system variables and mining model rule sets with one another resulting in an improved mining result.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

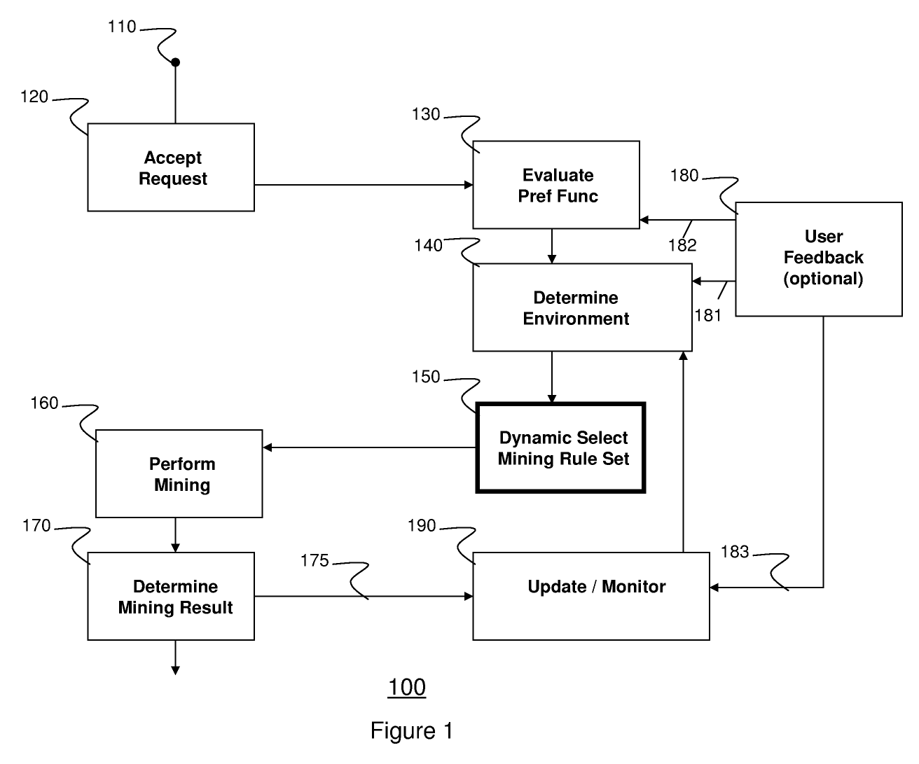

The present invention, in accordance with various implementations, is a method for dynamically determining data mining results using a dynamic data mining model within a data mining system. FIG. 1 shows an operative flowchart for a data mining server 100 in accordance with an implementation of the present invention.

From the implementation depicted in FIG. 1, a data mining server 100 within a data system (not pictured), following initiation at 110, accepts a mining request for a mining task at 120. A request may be a task, an event or an activity-based request to associate incoming data to the data mining server with classes or groups of data (i.e., basic classification functionality). A class of data may be associated with an activity on the server or the data system. For instance, by way of example, an event request may include the task of determining a classification (i.e., activity label, or class labeling) for an incoming message in relation to one of message header data, message content and attached data in the message (also used herein as “Message Example”). Although the implementation set forth in FIG. 1 is for data mining with classes or classification functionality, it will be readily understood by those in the field that the present invention, in further implementations, is not so limited and is suitably applicable for not only messaging classification, but general data mining for instance, in various aspects, as well.

The server 100 then evaluates the preference functions at 130. As used herein the preference function may include system state parameters or information relation to the system for instance, and a preference function itself can be specified by an administrator or a particular tool (i.e., an on demand tool) such that the representative form of the preference function may be basic or complex, depending on the situation. Preference functions may also include system environment parameters (i.e., cost, quality, time, etc.) and mining quality measures for instance. In still other aspects of the present invention in various implementations, the preference functions may represent a sample business objective in certain situations and differing constraints in other situations.

Once the preference functions are evaluated, the server is able to determine the environment for the event at hand, at 140.

In a particular implementation, a “preference function is represented as a set of “IF . . . THEN” rules that refer to system state parameters which are expressed as predetermined variables such “CPU usage.” In this implementation, the representation may be set forth via an interface for the user, where the rule set may include:

IF cpu usage>90% THEN use “high efficiency” set of mining rules;

IF cpu usage>60% AND “CPU usage”<=90% THEN use “normal” set of mining rules;

ELSE use “high quality” set of mining rules.

In other implementations, it will be understood that the present invention is not so limited as other representations of the preference function are possible, e.g. in the form of numerical functions.

Thereafter, once the environment is determined, the server 100 selects a mining rule set at 150. The selected mining rule set is one a plurality of mining rule sets created by the mining model (not pictured) and described further below. The server then performs the event and undertakes to the mining task in relation to the selected mining rule set at 160. Once the mining task is completed, a set of results of the mining task is determined and made available at 170.

Optionally, in an alternate implementation, during mining, the mining server performs a monitoring of the costs of computation and the quality differences between alternative non-selected mining rule sets from the plurality of mining rule sets, and updates the cost and quality parameters according to empirically gained values.

In a further implementation of the present invention, an optional feedback sequence provides for user feedback to be timely included so as to influence, as appropriate, a determination by the server as to the environment, at 140. Optionally, user feedback of 180 may be received by the server at the determining step 140 along 181, at the preference function evaluation step 130 along 182, and/or at the monitor and update step 190 along 183, or along 175 where interim results may be returned for evaluation, in both cases which affect the environment determination step 140.

In this optional step, user feedback on a related interest, such as interim mining results, may create a negative feedback. When the negative feedback is received along 182 at the preference function evaluation step 130, the preference function will be influenced by the received feedback. In response to the received feedback, based on the preference function, at least in part, the server may determine that the environment is different than it would have been had the feedback not been included or received, which would therefore possibly cause a different mining rule set to be selected at 150. In this optional step then, the server dynamically determines whether recent activities effect the environment.

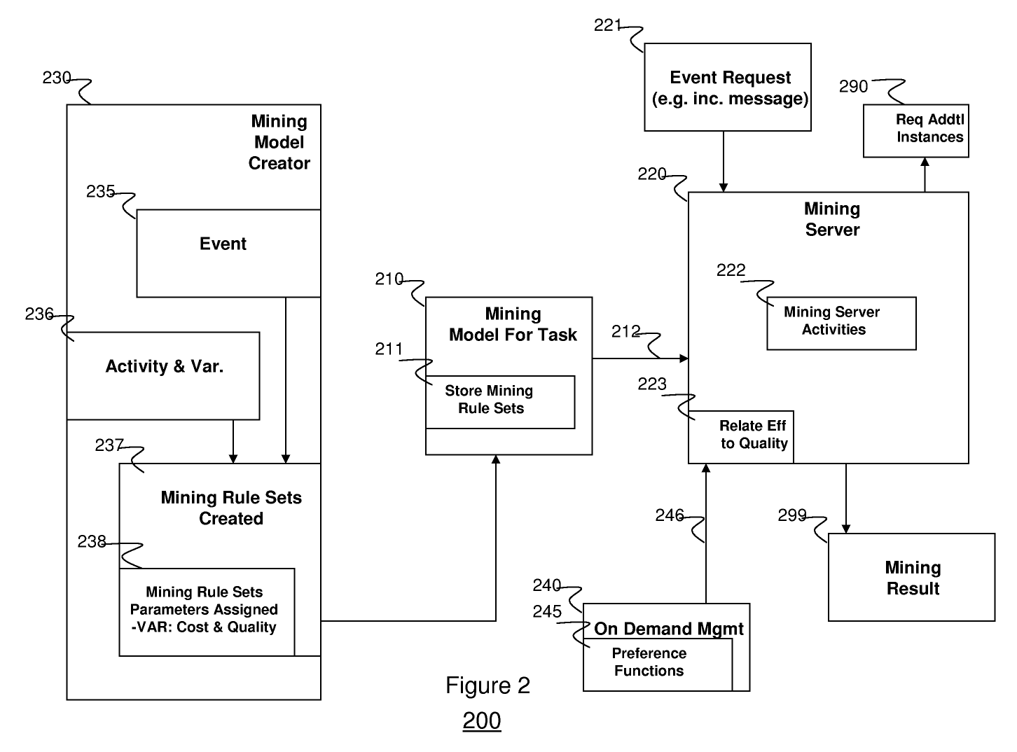

FIG. 2 depicts a system 200 for dynamically determining data mining results using a mining model 210 with a data mining server 220 in a data mining system 200 in accordance with an implementation of the present invention.

From the implementation depicted in FIG. 2, a mining server 220 (also used herein as a “data mining server,” a “data server,” and also a “server” which each are intended to be used interchangeably) is used to associate incoming messages 221 with ongoing activities 222 of the data system. For instance, using the Message Example from above, a mining task would include determining a classification (i.e. the activity label or class label) based on message header data, message content and attached data to a message. Although the implementation set forth in FIG. 2 is one particular implementation, it will be readily understood by those in the field that the present invention, in further implementations, is not so limited and is suitably applicable for not only messaging classification, but general data mining for instance, in various aspects, as well.

A Mining Model Creator 230 creates a Mining Model for a task 210 in relation to a task or event 235 and activities or dynamic environment variables 236. The dynamic environment variables may include business objectives directly or indirectly, or variables such as cost, quality, timing, and the like, for instance.

For instance, for the Mining Model Creator 230 using the Message Example, the event of 235 is an activity labeling, the variables are cost and quality at 236, and there is business objectives associated with message header, message content and attached text. The Mining Model Creator would therefore create three mining rule sets at 237, where each is targeted for the different business objectives as:
Set 1: only refers to message header attributes, which may be computed by the mining server very efficiently;
Set 2: refers to message header attributes and message content, but does not refer to attached text documents, which may be computed efficiently (as large processing of unstructured text data is not required), but usually achieve better mining quality; and,
Set 3: refers to message header attributes and message content and all attached text documents, which yields the best mining quality, but are complex to compute and thus create high system load on the messaging server.

At 238, since the variable are based on cost and quality in the Message Example, the Mining Model Creator assigns each set of mining rules a cost parameter representing the computing costs and a quality parameter.

Thereafter, mining rule sets including the parameters and the relational information are stored in one mining model for the task at 211. The mining model of 210 is for a particular task and contains a plurality of functionally equivalent mining rule sets, each of which differs operationally from another due to each having a unique set of performance or metric characteristics. Once the mining rule sets are stored at the Mining Model 210, the Mining Model is deployed for use by the server along 212. For the Message Example, a total of three mining rule sets are stored at 211.

From the implementation depicted in FIG. 2, at 240, an on demand management function provides preference functions 245 to the mining server along 246. The preference functions may represent, for instance, a sample business objective which places a preference of efficiency over quality, or vice versa. By example in the former instance, a sample business objective may include “in normal situations the mining server has to be sufficiently efficient such that it can run on one small Unix box.” Contradistinctively, during an ongoing spam attack for instance, a preference function may be provided which prefers the latter instance where quality over efficiency is prioritized in order to eliminate most of the incoming spam. In this situation, the present invention in it various implementations is capable of recognizing that current server capacity may not be sufficient and may request additional mining server instances from elsewhere, such as at 290.

A server of the present invention 220 is able to then relate the relationship between efficiency and quality at 223 along with the preference functions received, the event request 221 and the selected mining rule set with respect to the system environment determined as part of the activities 222, to produce a mining result at 299.

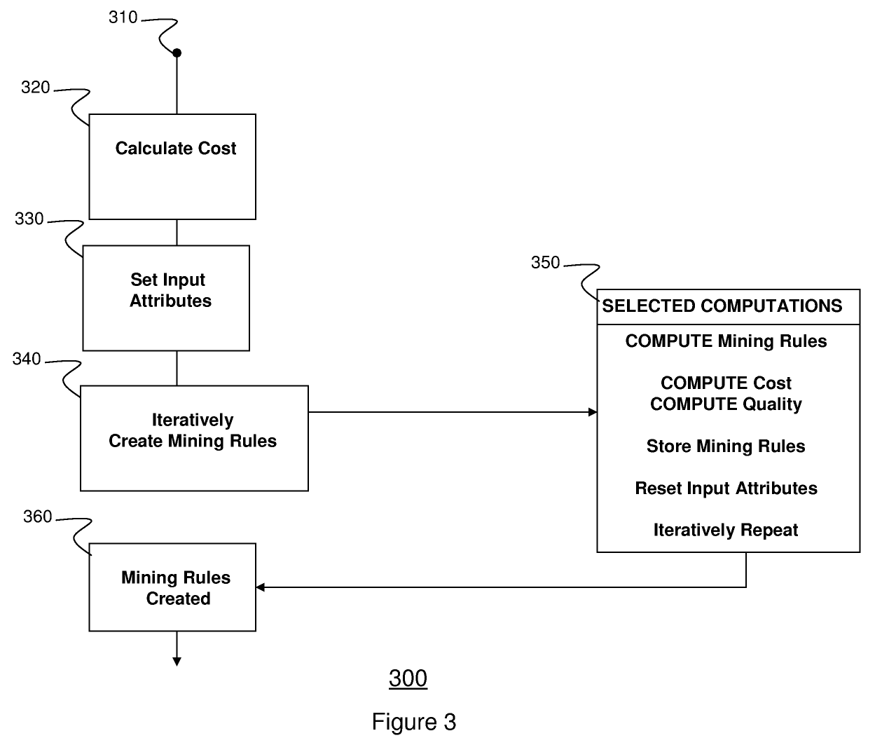

FIG. 3 depicts a process 300 for creating mining rule sets within a mining model creation scheme by using selected computations 350 in accordance with an implementation of the present invention.

From the implementation depicted in FIG. 3, at 310 a mining rule creation process is initiated by a mining model creator (not pictured), where the mining model creator creates mining rules in accordance with certain modeling heuristics. At 320, the creator calculates the costs for evaluating the data attributes, and at 330 input attributes are fixed in accordance with: set input attributes=data attributes.

Then the creator iteratively creates a plurality of sets of mining rules at 340, where certain steps are undertaken at 350 including: computing mining rules for the current set of input attributes (e.g., Tree classifiers or Clustering); computing cost of mining rules (i.e., from cost model or by performing mining on test data set), computing quality by performing mining on test data set; storing mining rules in mining model; and resetting input attributes to equal input attributes less a predetermined percentage of the most costly attributes until either no more attributes can be removed or quality is below a predetermined threshold. Once the steps of 350 are undertaken, a completed plurality of mining rule sets is readied with a mining model at 360. The mining model is ready to be deployed to its respective data mining server, where the mining model comprises a plurality of mining rule sets each of which are functionally equivalent, but operationally (e.g., performance, quality, etc.) different.

In a further implementation, the steps of 350 may include one or more pseudocode fragments, software script, or other instruction or program set to determine a step sequence as further set forth below by example:

### COMPUTE SET OF MINING RULES ACCORDING TO PRIOR ART

(input attributes are passed to a prior art data mining algorithm, e.g. tree classification or clustering)

(prepare cost calculation step) REGISTER SYSTEM ENVIRONMENT MONITOR

FOR EACH DATA RECORD IN THE TEST DATA SET DO
CALCULATE THE MINING RESULT FOR THE DATA RECORD
COMPARE CALCULATED RESULT AND ACTUAL RESULT; ADJUST QUALITY INDEX

ENDDO

(calculate cost) READ SYSTEM STATE FROM SYSTEM ENVIRONMENT MONITOR (e.g. from cpu usage, memory consumption, . . . ); DETERMINE COST OF EVALUATION OF INPUT ATTRIBUTES; RESULTING IN A COST INDEX FOR EACH INPUT ATTRIBUTE

STORE MINING RULES; QUALITY INDEX; EFFICIENCY INDEX

LET INPUT ATTRIBUTES=INPUT ATTRIBUTES MINUS SET OF X % OF THE MOST COSTLY INPUT ATTRIBUTES (calculate new set of input attributes for next iteration)

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

In addition to the processes and implementations of the present invention described thus far, the invention may also be used for data management, data integrity assessment, data systems development, and the like, whether automated in a program instruction set, operational or planned to be operational in a system, or manually defined by a user.

What is claimed is:

1. A method for dynamically determining data mining results using a dynamic data mining model within a data mining system having a data mining server, the method comprising:
accepting an event request;
receiving one or more preference functions for evaluation in relation to one or more dynamic environmental variables,
receiving a mining model for the event request, wherein the mining model is unique to the event, comprises a plurality of mining rule sets iteratively determined in relation to the event and one or more business objectives and selected computations representing one or more preference functions, and wherein each mining rule set of the mining model consists of common functionality with each other mining rule set, and each mining rule set is operatively unique from each other mining rule set in relation to the variables,
evaluating the received preference functions to determine a system environment for the event request
identifying a selected mining rule set from the plurality of rule sets of the mining model,
performing a mining operation in relation to the event request and the selected mining rule set, and
determining data mining results for the mining operation.

2. The method of claim 1, wherein the dynamic environmental variables are efficiency and quality, and the preference functions include one or more system state characteristics.

3. The method of claim 2, wherein the data mining system comprises a plurality of servers wherein at least one of the plurality of servers is a data mining server.

4. The method of claim 3, further comprising a step of the server receiving feedback information prior to evaluating the received preference functions and further considering the received feedback information to finally determine a system environment for the event request.

5. The method of claim 4, wherein one or more of the feedback information and determined data mining results are received by the server prior to evaluating the received preference functions and further considering the received one or more of the feedback information and determined data mining results to finally determine a system environment for the event request.

6. A computer program product for adaptively determining data mining results using a dynamic data mining model within a data mining system having one or more servers wherein at least one of the one or more servers is a data mining server, the computer program product comprising a computer-readable storage medium having computer-readable program code portions stored therein, the computer-readable program code portions comprising: a first executable portion instructing the data mining server to be capable of:
accepting an event request;
receiving one or more preference functions in relation to one or more system state characteristics for evaluation in relation to one or more dynamic environmental variables of efficiency and quality,
receiving a mining model for the event request, wherein the mining model is unique to the event, comprises a plurality of mining rule sets iteratively determined in relation to the event and one or more business objectives and selected computations, and wherein each mining rule set of the mining model consists of common functionality with each other mining rule set, and each mining rule set is operatively unique from each other mining rule set in relation to the variables,
evaluating the received preference functions to determine a system environment for the event request
identifying a selected mining rule set from the plurality of rule sets of the mining model,
performing a mining operation in relation to the event request and the selected mining rule set,
determining data mining results for the mining operation, and
reporting data mining results in relation to the event request.

7. The product of claim 6, further comprising receiving feedback information prior to evaluating the received preference functions and further considering the received feedback information to finally determine a system environment for the event request.

8. The product of claim 7, wherein one or more of the feedback information and determined data mining results are received by the server prior to evaluating the received preference functions and further considering the received one or more of the feedback information and determined data mining results to finally determine a system environment for the event request.

9. The product of claim 8, wherein the event request is a task to determine activity labeling for incoming messages in relation to one or more of an incoming message header data, message content and message attachment.

10. The product of claim 9, wherein the selected computations further comprise steps including: computing mining rules for the current set of input attributes (e.g., Tree classifiers or Clustering); computing cost of mining rules (i.e., from cost model or by performing mining on test data set), computing quality by performing mining on test data set; storing mining rules in mining model; and resetting input attributes to equal input attributes less a predetermined percentage of the most costly attributes until either no more attributes can be removed or quality is below a predetermined threshold.

11. A data system for dynamically determining data mining results using a dynamic data mining model comprising one or more servers, wherein at least one of the one or more servers is a data mining server, a model creator, a created model, an on demand manager, and an event requester, each of which are in operable communication with one another, and where:
the data mining server is capable of
accepting an event request from the event requester;
receiving one or more preference functions from the on demand manager in relation to one or more system state characteristics for evaluation in relation to one or more dynamic environmental variables of efficiency and quality defined by the on demand manager,
receiving a created model for the event request created by the model creator, wherein the created model is unique to the event, comprises a plurality of mining rule sets iteratively determined in relation to the event and one or more business objectives and selected computations, and wherein each mining rule set of the created model consists of common functionality with each other mining rule set, and each mining rule set is operatively unique from each other mining rule set in relation to the variables,
evaluating the received preference functions to determine a system environment for the event request,
identifying a selected mining rule set from the plurality of rule sets of the created model,
performing a mining operation in relation to the event request and the selected mining rule set,
determining data mining results for the mining operation, and
reporting data mining results in relation to the event request,
wherein the creator conducts selected computations further having steps of: computing mining rules for the current set of input attributes (e.g., Tree classifiers or Clustering); computing cost of mining rules (i.e., from cost model or by performing mining on test data set), computing quality by performing mining on test data set; storing mining rules in mining model; and resetting input attributes to equal input attributes less a predetermined percentage of the most costly attributes until either no more attributes can be removed or quality is below a predetermined threshold.

12. The system of claim 11, wherein the event request is a task to determine activity labeling for incoming messages in relation to one or more of an incoming message header data, message content and message attachment.
